(19) United States
(12) Patent Application Publication
(10) Pub. No.: US 2010/0190434 A1
(43) Pub. Date: Jul. 29, 2010

(54) COMMUNICATION APPARATUS AND CONTROL METHOD THEREOF

(75) Inventor: Takahiro Shichino, Tokyo (JP)

Correspondence Address: COWAN LIEBOWITZ & LATMAN P.C.;JOHN J TORRENTE, 1133 AVE OF THE AMERICAS, NEW YORK, NY, 10036, US

(73) Assignee: CANON KABUSHIKI KAISHA, Tokyo (JP)

(21) Appl. No.: 12/691,519

(22) Filed: Jan. 21, 2010

(30) Foreign Application Priority Data
Jan. 27, 2009 (JP) 2009-015589

(51) Int. Cl. H04B 7/24

(52) U.S. Cl. 455/26.1; 455/39

(57) ABSTRACT

In order to provide a technique that facilitates the setting and management of communication parameters, a communication apparatus comprises: an acquisition unit configured to acquire geographic position information indicating a position where the communication apparatus exists; and a determination unit configured to determine availability of a communication parameter to be used when communicating with another apparatus, based on the position information acquired by the acquisition unit.

### BACKGROUND OF THE INVENTION

1. Field of the Invention

The present invention relates to the technique of setting and managing a communication parameter.

2. Description of the Related Art

Recently, wireless LANs are increasingly incorporated into electronic apparatuses such as a digital still camera (to be referred to as a DSC hereinafter) and a printer. To wirelessly connect apparatuses by using a wireless LAN, it is necessary to set communication parameters such as a service set ID (SSID) and encryption key, but the setting is generally troublesome. Especially in an ad-hoc network configuration in which each terminal generates communication parameters on the spot when starting communication, a large number of communication parameters must be prepared beforehand. Therefore, a user must perform a complicated operation of selecting one of the many communication parameters.

On the other hand, a technique of simply setting communication parameters has been developed. As an example, Japanese Patent Laid-Open No. 2005-286941 has proposed a method of setting and managing communication parameters by using a two-dimensional barcode in which the expiration range is recorded together with access point information.

The above-mentioned method effectively reduces the labor of parameter selection when connecting to an access point installed in a predetermined geographic position in advance, but cannot be an effective solution in the ad-hoc network configuration. That is, in the ad-hoc network configuration in which each terminal generates communication parameters on the spot when starting communication, the effective conditions of the communication parameters cannot be set in accordance with preset geographic conditions. Accordingly, a large number of communication parameters must be prepared beforehand in the ad-hoc network configuration, and this is troublesome for users.

### SUMMARY OF THE INVENTION

According to one aspect of the present invention, a communication apparatus comprises: an acquisition unit configured to acquire geographic position information indicating a position where the communication apparatus exists; and a determination unit configured to determine availability of a communication parameter to be used when communicating with another apparatus, based on the position information acquired by the acquisition unit.

According to another aspect of the present invention, a communication apparatus comprises: an acquisition unit configured to acquire geographic position information indicating a position where the communication apparatus exists; and a decision unit configured to decide a geographic range within which a communication parameter to be used when communicating with another apparatus is usable, based on the position information acquired by the acquisition unit.

According to still another aspect of the present invention, a communication apparatus comprises: a receiving unit configured to receive a communication parameter to be used when communicating with another apparatus, and range information indicating a geographic range within which the communication parameter is usable; an acquisition unit configured to acquire geographic position information indicating a position where the communication apparatus exists; and a determination unit configured to determine availability of the communication parameter based on the position information acquired by the acquisition unit and the range information received by the receiving unit.

According to yet another aspect of the present invention, a control method of a communication apparatus, comprises the steps of: acquiring geographic position information indicating a position where the communication apparatus exists; and restricting use of a communication parameter to be used when communicating with another apparatus, based on the position information acquired in the acquiring step.

According to still yet another aspect of the present invention, a control method of a communication apparatus, comprises the steps of: acquiring geographic position information indicating a position where the communication apparatus exists; and deciding a range which restricts use of a communication parameter to be used when communicating with another apparatus, based on the position information acquired in the acquiring step.

According to yet still another aspect of the present invention, a control method of a communication apparatus, comprises the steps of: receiving a communication parameter to be used when communicating with another apparatus, and range information indicating a geographic range within which the communication parameter is usable; acquiring geographic position information indicating a position where the communication apparatus exists; and restricting use of the communication parameter based on the position information acquired in the acquiring step and the range information received in the receiving step.

The present invention can provide a technique that facilitates the setting and management of communication parameters.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a view showing the overall configuration of a wireless LAN system including wireless communication apparatuses (DSCs) according to the first embodiment;

FIG. 2 is a view showing a basic sequence when three DSCs share a communication parameter;

FIG. 3 is a view showing the internal arrangement of a DSC as the wireless communication apparatus according to the first embodiment;

FIG. 4 is a view showing the initial state of a memory area managed by a communication parameter management unit 305;

FIG. 5 is an exemplary view showing the state of the communication parameter management unit 305 at the start of the generation of a communication parameter;

FIG. 6 is an exemplary view showing the state of the communication parameter management unit 305 after the communication parameter is shared;

FIG. 7 is a view showing the initial state of a memory area managed by a position information memory 306;

FIG. 8 is an exemplary view showing the state of the position information memory 306 after the communication parameter is shared;

FIG. 9 is a view showing the operation sequence of the three DSCs according to the first embodiment;

FIG. 10 is a flowchart showing details of the operation of the DSC of the first embodiment;

FIG. 11 is a view showing the state of the position information memory 306 of a DSC 101;

FIG. 12 is an exemplary view showing the state of the position information memory 306 after the communication parameter is shared;

FIG. 13 is a view showing the operation sequence of three DSCs according to the second embodiment;

FIG. 14 is a view showing the overall configuration of a wireless LAN system including a wireless communication apparatus (DSC) according to the third embodiment;

FIG. 15 is a view showing the state of the position information memory 306 of a DSC 102;

FIG. 16 is a view showing the operation sequence of two DSCs according to the third embodiment; and

FIG. 17 is a flowchart showing details of the operation of the DSC of the third embodiment.

### DESCRIPTION OF THE EMBODIMENTS

Preferred embodiments of the present invention will be explained in detail below with reference to the accompanying drawings. Note that the following embodiments are merely examples and do not limit the scope of the present invention.

### First Embodiment

The first embodiment of a communication apparatus according to the present invention will be explained below by taking as an example a wireless communication apparatus (wireless device) in a wireless LAN system that operates in the ad-hoc mode.

<System Configuration>

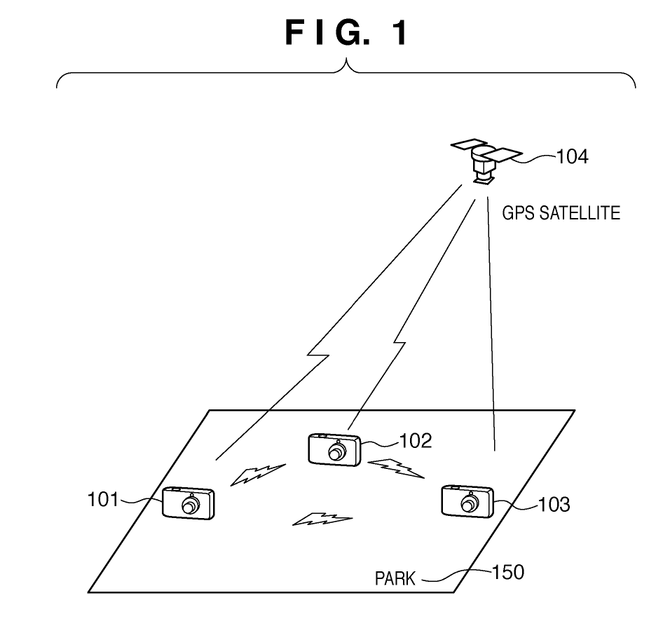

FIG. 1 is a view showing the overall configuration of a wireless communication system including digital still cameras (DSCs) as the wireless communication apparatuses according to the first embodiment. DSCs 101, 102, and 103 are positioned in the premises of a park 150. The DSCs 101, 102, and 103 each incorporate a GPS (Global Positioning System) receiver (a GPS unit 302). Therefore, each DSC can calculate geographic position information (e.g., the longitude and latitude) of the apparatus based on radio waves received by the GPS unit 302 from a plurality of GPS satellites including a GPS satellite 104. Note that various algorithms are known as the calculation algorithm, and an arbitrary algorithm can be used. The DSCs 101, 102, and 103 each include a transmitter/receiver (a wireless LAN unit 301: a transmitting/receiving unit) complying with the standards of a wireless LAN. The three DSCs are configured to be able to communicate with each other by setting a common communication parameter in their wireless LAN units by a communication parameter setting method (to be described later).

<Apparatus Arrangement>

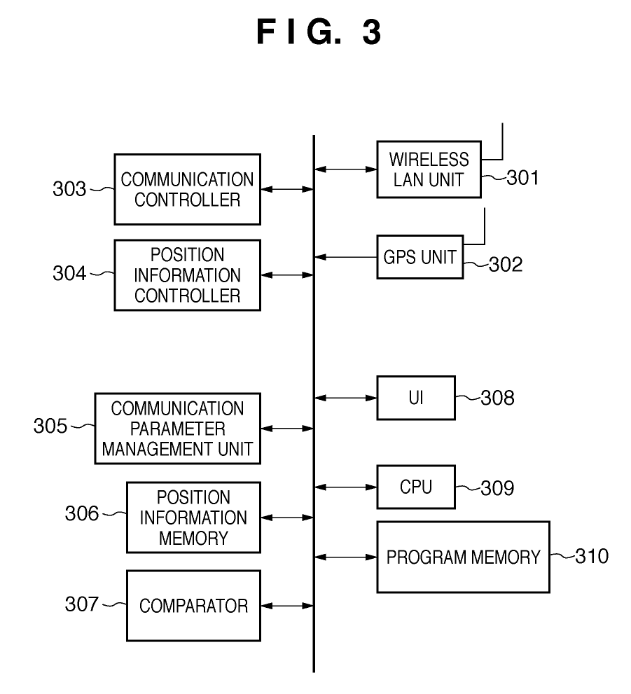

FIG. 3 is a view showing the internal arrangement of a DSC as the wireless communication apparatus according to the first embodiment. The wireless LAN unit 301 is a functional unit that communicates with another wireless communication apparatus complying with a wireless LAN. Especially in the first embodiment, the wireless LAN unit 301 of each of the DSCs 101, 102, and 103 operates in the ad-hoc mode. The GPS unit 302 is a functional unit that receives radio waves transmitted from a plurality of GPS satellites, and calculates information of the position where the GPS unit 302 exists.

A communication controller 303 is a functional unit that controls, for example, the connection/disconnection of a network by using the wireless LAN unit 301. A position information controller 304 is a functional unit that performs the operation of turning on and off the power supply of the GPS unit 302, and the operation of storing the position information in a position information memory 306. A communication parameter management unit 305 is a functional unit that stores communication parameters such as an SSID and encryption key to be used in the wireless LAN unit 301, and manages the valid/invalid of each communication parameter. The position information memory 306 is a functional unit that stores the position information calculated by the GPS unit 302, and the effective conditions of the communication parameters stored in the communication parameter management unit 305. Note that details of the effective conditions will be described later.

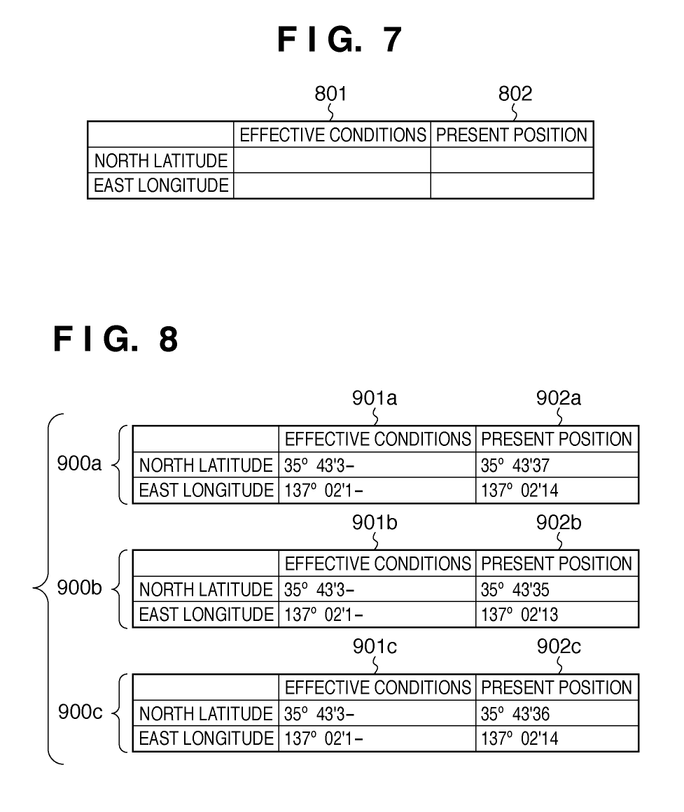

FIG. 7 shows the initial state of a memory area managed by the position information memory 306. Reference numeral 801 denotes an area for storing the effective conditions of a communication parameter; and 802, an area for storing the position information of the present position of the DSC.

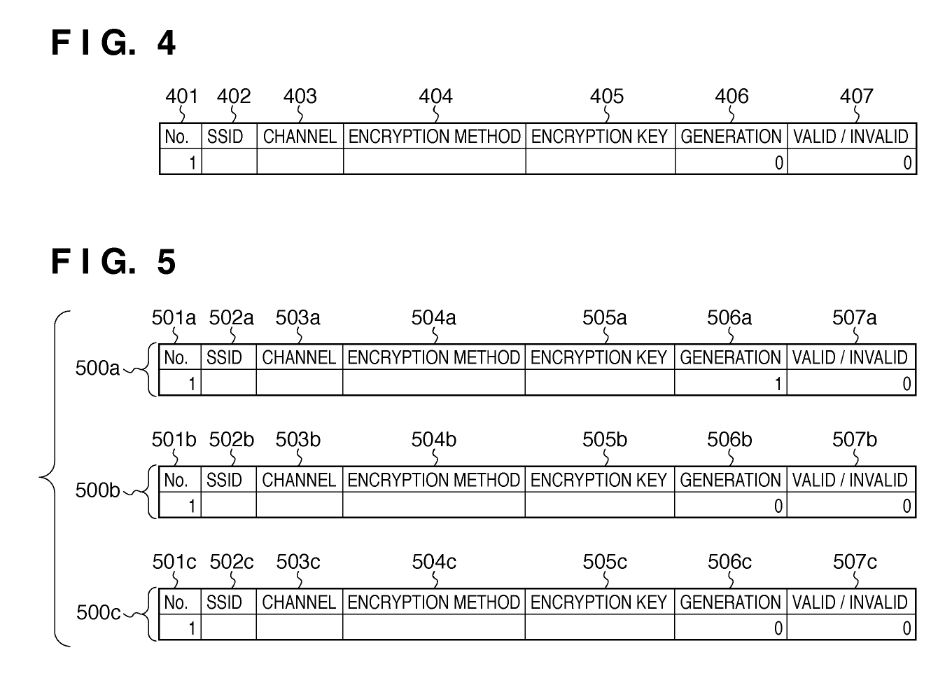

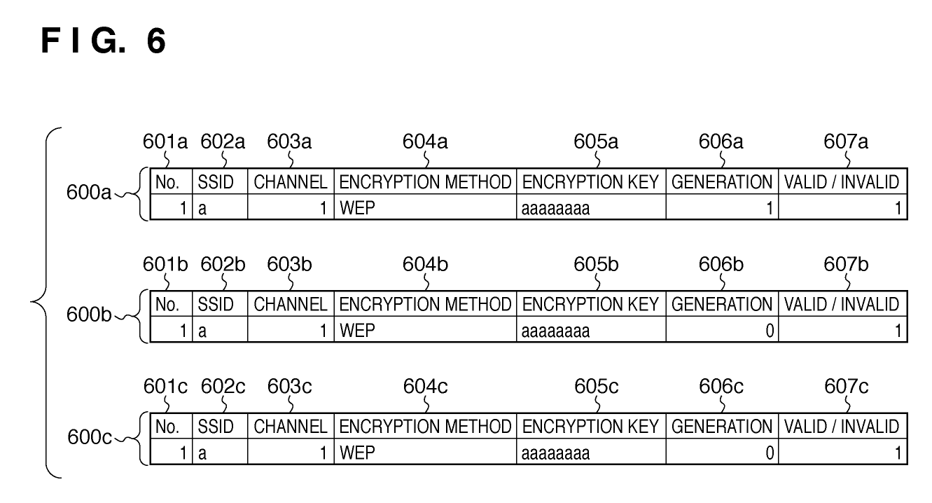

FIG. 4 shows the initial state of a memory area managed by the communication parameter management unit 305. Reference numeral 401 denotes the serial number of a communication parameter; 402, an SSID; 403, a channel to be used; 404, an encryption method; 405, an encryption key; and 406, a generation flag indicating whether the DSC is a communication parameter generating side or communication parameter receiving side. In the following example, “1” is stored if the DSC is the communication parameter generating side, and “0” is stored if the DSC is the communication parameter receiving side. Reference numeral 407 denotes a valid/invalid flag indicating whether the communication parameter is valid. The explanation will be made by assuming that “1” is set if the communication parameter is valid and “0” is set if it is invalid.

A comparator 307 is a functional unit that compares the position indicated by the position information 802 stored in the position information memory 306 with the geographic area indicated by the effective conditions 801, thereby determining the availability of the communication parameter. A user interface (UI) 308 provides information to the user and accepts instructions from the user. For example, the UI 308 includes a liquid crystal display and various buttons. A central processing unit (CPU) 309 controls the above-mentioned functional units by executing control programs stored in a program memory 310. The CPU 309 also executes various operations (to be described later) by executing control programs stored in the program memory 310. The program memory 310 stores the programs to be executed by the CPU 309.

<Operations of Apparatus>

### Basic Operation

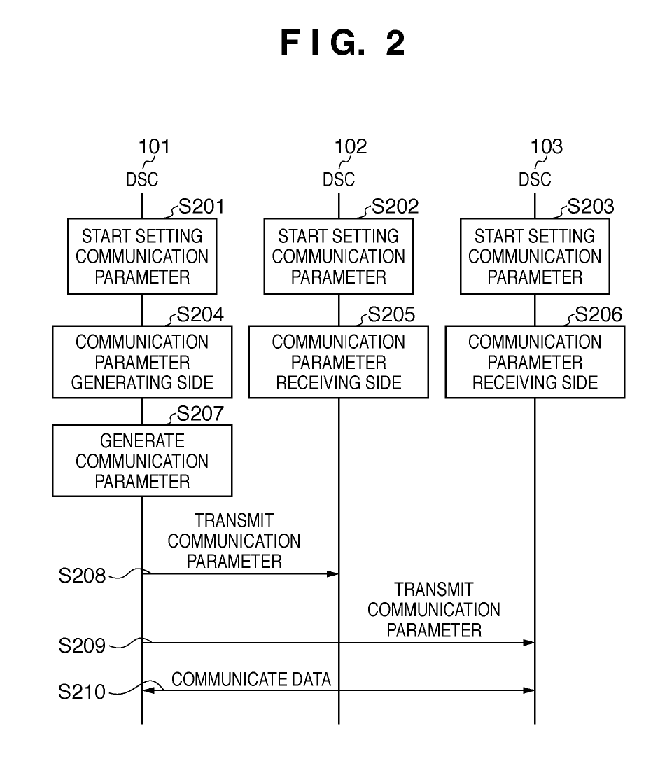

FIG. 2 is a view showing a basic sequence when the three DSCs share a communication parameter.

First, the three DSCs, that is, the DSCs 101, 102, and 103 start a communication parameter setting process (S201, S202, and S203). Then, an apparatus that generates a communication parameter and an apparatus that receives the generated communication parameter are decided (S204, 5205, and S206). Whether to use the DSC as a communication parameter generating apparatus or communication parameter receiving apparatus is decided by a predetermined algorithm. Examples are an algorithm by which an apparatus on which the user starts the communication parameter setting process earliest is set as a generating apparatus, and an algorithm by which one of apparatuses having started the communication parameter setting process is set as a generating apparatus based on apparatus identification information such as a MAC address.

Referring to FIG. 2, it is decided that the DSC 101 generates a communication parameter and the DSCs 102 and 103 receive the communication parameter. Therefore, the DSC 101 generates a communication parameter (S207), and transmits the generated communication parameter to the DSCs 102 and 103 (S208 and S209). Thus, the three DSCs, that is, the DSCs 101, 102, and 103 share the communication parameter generated by the DSC 101. After that, the DSCs 101, 102, and 103 set the shared communication parameter in their respective wireless LAN units 301, and perform data communication (S210). A method of setting effective conditions on a communication parameter (requirements that make the communication parameter usable) will be explained in detail below.

Details of Operation

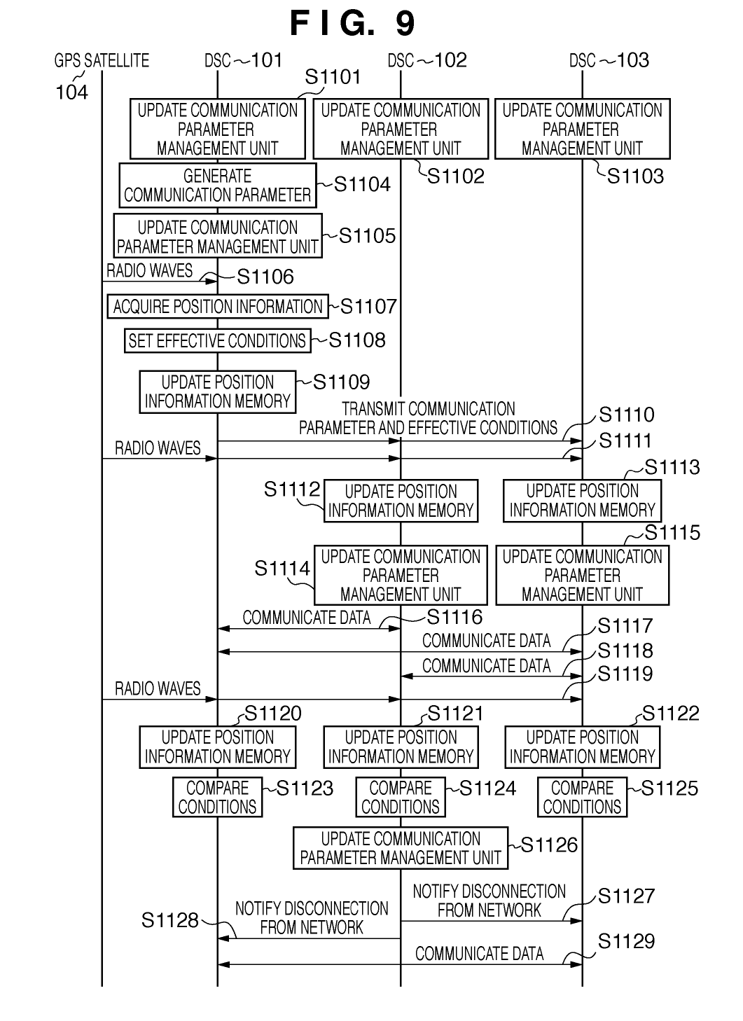

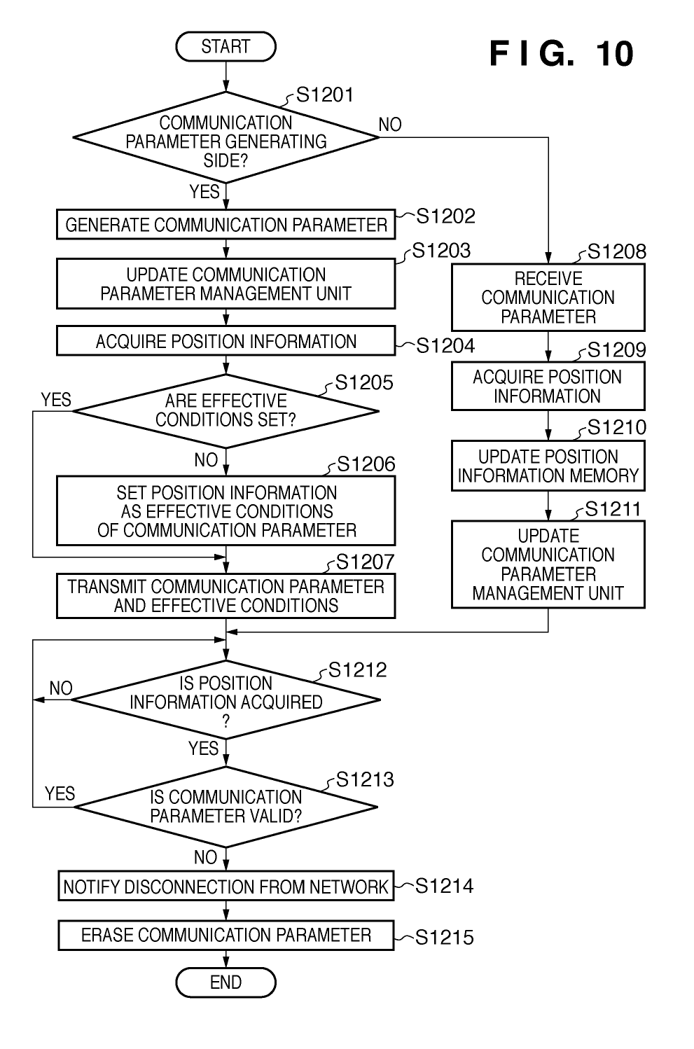

FIG. 9 is a view showing the operation sequence of the three DSCs according to the first embodiment. FIG. 10 is a flowchart showing details of the operation of the DSC of the first embodiment.

As explained in FIG. 2, the DSCs 101, 102, and 103 first start setting a communication parameter (S201, S202, and S203).

Subsequently, it is decided that the DSC 101 generates a communication parameter (S204) and the DSCs 102 and 103 receive the communication parameter (S205 and S206). The CPU 309 of the DSC 101 sets “1” in the generation flag of the communication parameter management unit 305 (S1101). Similarly, the CPU 309 of each of the DSCs 102 and 103 sets “0” in the generation flag of the communication parameter management unit 305 (S1102 and S1103).

FIG. 5 is an exemplary view showing the state of the communication parameter management unit 305 of each DSC at the start of the generation of a communication parameter. Reference numerals 500a, 500b, and 500c respectively indicate the states of the communication parameter mangers 305 of the DSCs 101, 102, and 103. At this point of time, no communication parameter has been generated yet. Therefore, no values corresponding to the SSID, channel, encryption method, and encryption key are stored, and values are written in only the generation flag and valid/invalid flag.

Since the DSC 101 is the communication parameter generating side (YES in S1201), the CPU 309 of the DSC 101 generates a communication parameter (S1104 and S1202). The CPU 309 stores the generated communication parameter in the communication parameter management unit 305 (S1105 and S1203).

Reference numeral 600a indicates the state of the communication parameter management unit 305 of the DSC 101 at this point of time. A value 602a of the SSID is “a”, a value 603a of the channel is “1 ch”, a value 604a of the encryption method is “WEP”, and a value 605a of the encryption key is “aaaaaaa”.

Then, the GSP controller 304 of the DSC 101 activates the GPS unit 302. The GPS unit 302 receives radio waves from the GPS satellite 104 and the like (S1106), and acquires the position information (S1107 and S1204). At this point of time, no effective conditions are set for the communication parameter (NO in S1205). Based on the acquired position information, therefore, the GPS controller 304 sets the values of effective conditions 901a of the position information memory 306 (S1108 and S1206). The GPS controller 304 also sets the values of a present position 902a of the position information memory 306 (S1109).

Reference numeral 900a in FIG. 8 indicates the state of the position information memory 306 of the DSC 101 at this point of time. FIG. 8 exemplarily shows that “thirty-five degrees forty-three minutes thirty-seven seconds of north latitude, a hundred and thirty-seven degrees two minutes fourteen seconds of east longitude” is obtained as the position information of the present position of the DSC 101. As the effective conditions, range information is set such that the units digit of the second (angle) of each of the latitude and longitude of the present position is “indefinite”. Accordingly, the effective conditions 901a of the communication parameter are set such that “thirty-five degrees forty-three minutes thirty seconds of north latitude to thirty-five degrees forty-three minutes forty seconds of north latitude” and “a hundred and thirty-seven degrees two minutes ten seconds of east longitude to a hundred and thirty-seven degrees two minutes twenty seconds of east longitude”. Note that “-” indicates aforementioned “indefinite” in FIG. 8.

The CPU 309 of the DSC 101 updates the position information memory 306 (S1109), and transmits the decided communication parameter and effective conditions to the DSCs 102 and 103 (S1110 and S1207).

The CPU 309 of the DSC 102 receives the communication parameter and effective conditions from the DSC 101 (S1208). The GPS controller 304 activates the GPS unit 302. The GPS unit 302 of the DSC 102 receives radio waves from the GPS satellite 104 and the like (S1111), and acquires its own position information (S1209).

The GPS controller 304 of the DSC 102 stores the acquired position information as a present position 902b in the position information memory 306. The GPS controller 304 also stores the effective conditions received in S1208 as effective conditions 901b (S1112 and S1210). Reference numeral 900b indicates the position information memory 306 of the DSC 102 in this state. As indicated by 900b, the effective conditions 901b are the same as the effective conditions 901a of the DSC 101.

Similar to the DSC 102, the DSC 103 receives the communication parameter and effective conditions from the DSC 101 in S1208. The GPS controller 304 of the DSC 103 activates the GPS unit 302. The GPS unit 302 receives radio waves from the GPS satellite 104 and the like (S1111), and acquires its own position information (S1209). The GPS controller 304 stores the acquired position information as a present position (902c) in the position information memory 306. The GPS controller 304 also stores the effective conditions received in S1208 as effective conditions 901c (S1113 and S1210). Reference numeral 900c indicates the position information memory 306 of the DSC 103 in this state. As indicated by 900c, the effective conditions 901c are naturally the same as the effective conditions 901a of the DSC 101.

In this manner, the DSCs 101, 102, and 103 share the same communication parameter and effective conditions. The DSCs 101, 102, and 103 perform data communication by using the communication parameter (S1116, S1117, and S1118).

After that, the DSCs 101, 102, and 103 receive radio waves from the GPS satellite 104 and the like (S1119), and regularly or irregularly acquire the position information (YES in S1212). In the following explanation, the DSCs 101 and 103 have not moved from the positions where they received the radio waves in S1111, and only the DSC 102 has moved.

The GPS controllers 304 of the DSCs 101, 102, and 103 update the present positions (902a, 902b, and 902c) in the position information memories 306. Since the DSCs 101 and 103 have not moved, their present positions are the same as those indicated by 902a and 902c. On the other hand, the present position stored in the position information memory 306 of the DSC 102 is, for example, “thirty-five degrees forty-three minutes thirty-five seconds of north latitude, a hundred and thirty-seven degrees two minutes twenty-one seconds of east longitude”.

After the position information is updated, the comparator 307 of each DSC compares the effective conditions in the position information memory 306 with the present position (S1124), thereby determining the availability of the communication parameter. Since the DSCs 101 and 103 have not moved, the position information of the present position of each DSC is naturally contained in the effective conditions. On the other hand, the DSC 102 meets the effective condition on the latitude, but does not meet that on the longitude. Therefore, the comparator 307 of the DSC 102 determines that the communication parameter is unavailable (invalid) (NO in S1213).

Accordingly, the CPU 309 of the DSC 102 sets “0” in the valid/invalid flag of the communication parameter management unit 305 (S1126). The CPU 309 of the DSC 102 then notifies the DSCs 101 and 103 of disconnection from the network via the wireless LAN unit 301 (S1127, S1128, and S1214). The CPU 309 also erases the communication parameter from the communication parameter management unit 305 (S1126 and S1215). In this state, the communication parameter management unit 305 of the DSC 102 has returned to the initial state shown in FIG. 4.

The DSCs 101 and 103 can continue the data communication because their present positions meet the effective conditions (S1129).

When using the wireless communication apparatus according to the first embodiment as has been explained above, the effective conditions (geographic range) of a communication parameter are decided based on the position information when the communication parameter is generated, and the individual terminals share the effective conditions. Since each terminal regularly or irregularly acquires the present position and compares it with the effective conditions, the effective range of the communication parameter can be defined (restricted) by the geographic range. That is, the user of the DSC need not perform any complicated operation of selecting one of a large number of communication parameters. Since the user can select one of a few communication parameters, the operability improves.

Note that the first embodiment has been explained by taking for example a parameter used in a wireless LAN as the communication parameter. However, the first embodiment is also applicable to another wireless communication system.

Note also that in the first embodiment, the communication parameter is erased if it does not meet the effective conditions any longer. However, it is also possible to disable communication by another method. For example, it is possible to use a method that keeps storing the communication parameter but does not display it on the UI 308.

Furthermore, the range information using the latitude and longitude has been explained as the effective conditions in the first embodiment. However, another information may also be used as long as the information is geographic. The same effect can be obtained even when the effective conditions are address information or information on the relative distance between DSCs.

### Second Embodiment

The second embodiment is an example in which when a communication request is received from an external wireless communication apparatus, whether to permit communication using a communication parameter is decided based on position information of the present position of the external wireless communication apparatus. Note that the system configuration and apparatus arrangement are almost the same as those of the first embodiment, so a repetitive explanation will be omitted.

<Operation of Apparatus>

Similar to the first embodiment, an example in which a DSC 101 generates a communication parameter and effective conditions will be explained below.

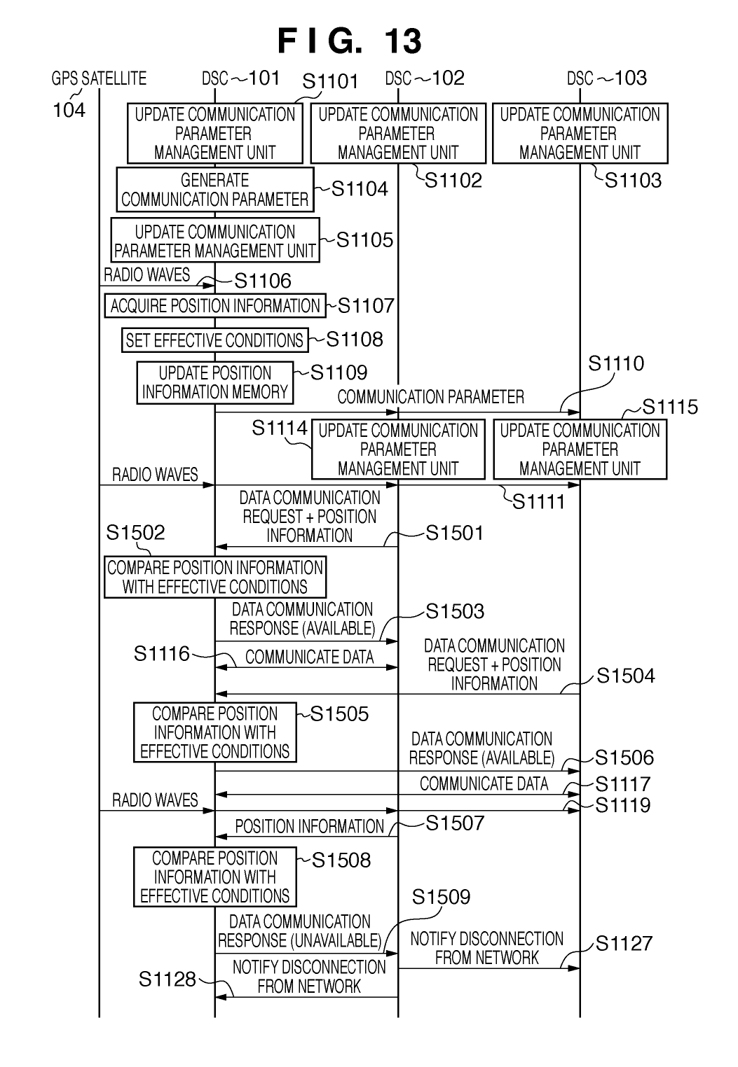

FIG. 13 is a view showing the operation sequence of three DSCs according to the second embodiment. Note that the generation of the communication parameter and the setting of the effective conditions (S1104 to S1108) are the same as those of the first embodiment. However, the DSC 101 transmits only the communication parameter to DSCs 102 and 103, and the three DSCs share only the communication parameter.

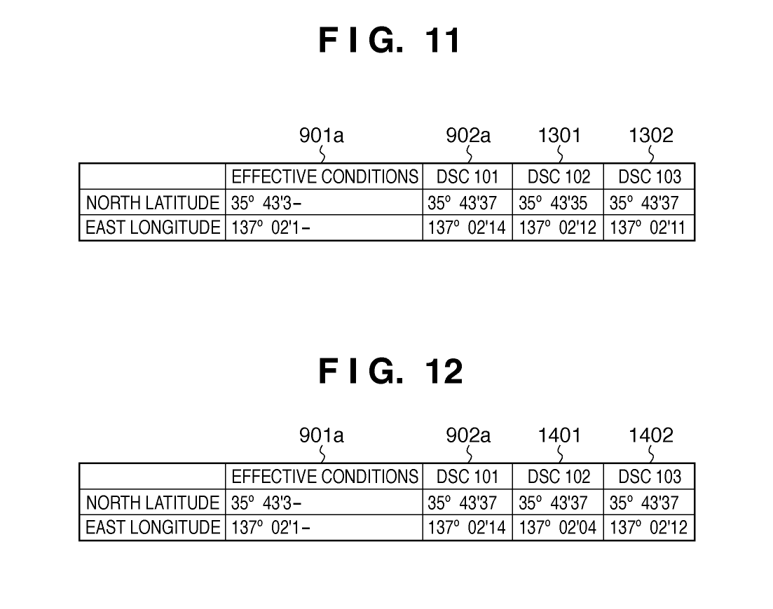

FIG. 11 is a view showing the state of a position information memory 306 of the DSC 101. The position information memory 306 of the DSC 101 is configured to store a present position 1301 of the DSC 102 and a present position 1302 of the DSC 103, in addition to a present position 902a and effective conditions 901a of the DSC 101.

The DSC 102 acquires its own position information based on radio waves received in S1111, and transmits the position information together with a data communication request (connection request) to the DSC 101.

The DSC 101 receives the data communication request and position information from the DSC 102 in S1501. A GPS controller 304 of the DSC 101 stores the position information as a corresponding value in the field 1301 of the present position of the DSC 102. After that, a comparator 307 compares the effective conditions 901a of a communication parameter with the present position 1301 of the DSC 102 (S1502).

In the example shown in FIG. 11, the present position 1301 of the DSC 102 satisfies the effective conditions 901a. Therefore, a CPU 309 of the DSC 101 transmits a data communication response (available) to the DSC 102 via a wireless LAN unit 301, thereby permitting data communication (S1503).

On the other hand, the DSC 101 receives a data communication request and position information from the DSC 103 in S1504. The GPS controller 304 of the DSC 101 stores the position information as a corresponding value in the field 1302 of the present position of the DSC 103. After that, the comparator 307 compares the effective conditions 901a of the communication parameter with the present position 1302 of the DSC 103 (S1505).

In the example shown in FIG. 11, the present position 1302 of the DSC 103 satisfies the effective conditions 901a. Therefore, the CPU 309 of the DSC 101 transmits a data communication response (available) to the DSC 103 via the wireless LAN unit 301, thereby permitting data communication (S1506).

Assume that the position of the DSC 102 has moved after that. The DSC 102 receives a radio wave from a GPS satellite 104 again (S1119), and retransmits the position information to the DSC 101 (S1507).

In S1507, the DSC 101 receives the position information from the DSC 102. The GPS controller 304 of the DSC 101 stores the position information as a corresponding value in the field 1301 of the present position of the DSC 102. After that, the comparator 307 of the DSC 101 compares the effective conditions 901a of the communication parameter with the present position 1301 of the DSC 102 (S1508).

Assume that the position information which the DSC 101 has received from the DSC 102 is a present position 1401 shown in FIG. 12. In this case, the comparator 307 of the DSC 101 determines that the effective condition on the latitude is met but that on the longitude is not met. Therefore, the DSC 101 transmits a data communication response (unavailable) to the DSC 102 via the wireless LAN unit 301 (S1509).

When receiving the data communication response (unavailable) from the DSC 101, the CPU 309 of the DSC 102 notifies the DSCs 101 and 103 of disconnection from the network via the wireless LAN unit 301 (S1127 and S1128). After that, the CPU 309 erases the communication parameter from a communication parameter management unit 305.

As has been explained above, when receiving a communication request from an external wireless communication terminal, the wireless communication apparatus according to the second embodiment decides whether to permit communication using a communication parameter based on the position information of the present position of the external wireless communication terminal. An apparatus having generated a communication parameter is regularly or irregularly notified of the present position of each terminal, and compares the effective conditions with the present position of each apparatus. This makes it possible to define (restrict) the effective range of the communication parameter by the geographic range.

### Third Embodiment

In the third embodiment, an example in which a communication request from an unintended wireless communication apparatus is also detected will be explained. Note that the apparatus arrangement is the same as that of the first embodiment, so a repetitive explanation will be omitted.

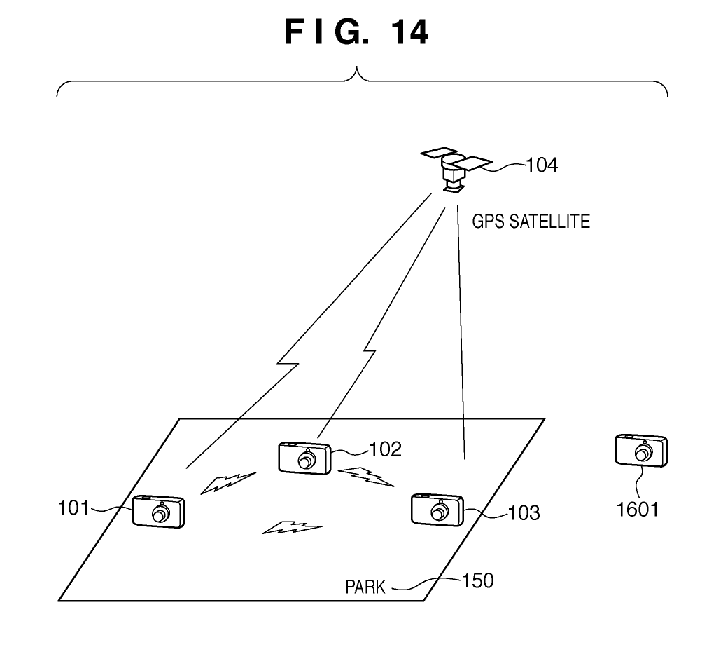

FIG. 14 is a view showing the overall configuration of a wireless LAN system including wireless communication apparatuses (DSCs) according to the third embodiment. A DSC 102 originally intends to exchange communication parameters with DSCs 101 and 103. However, the DSC 102 may exchange communication parameters with a DSC 1601 as an unintended partner. Accordingly, a method capable of detecting the sharing of a communication parameter with an unintended partner will be explained below.

<Operation of Apparatus>

In the following explanation, the DSC 1601 is a wireless communication apparatus having a function of generating a communication parameter and effective conditions. An operation when the DSC 102 has received the communication parameter and effective conditions from the DSC 1601 that is not an original communication partner will be explained.

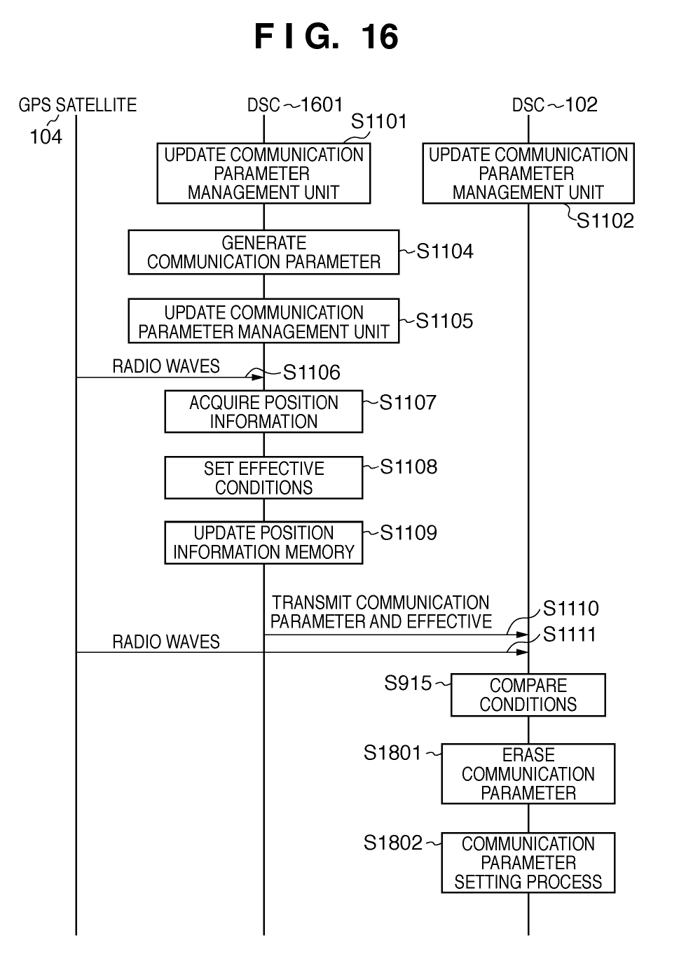

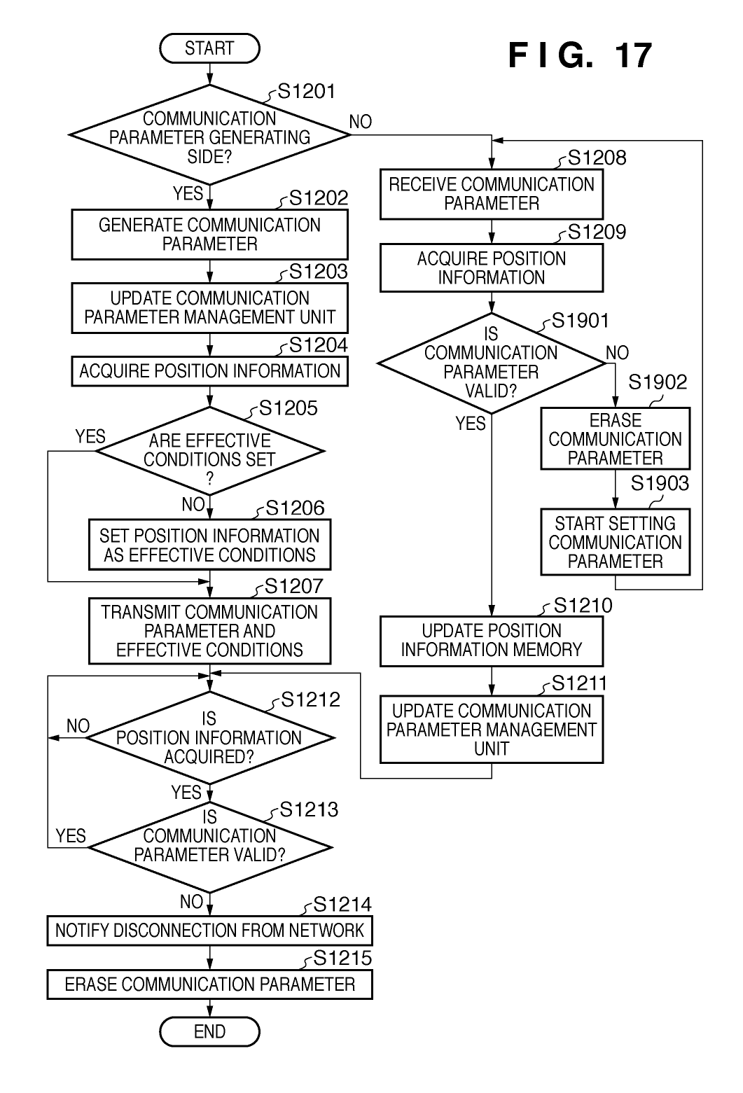

FIG. 16 is a view showing the operation sequence of two DSCs according to the third embodiment. FIG. 17 is a flowchart showing details of the operation in the DSC of the third embodiment.

The DSC 102 receives the communication parameter and effective conditions from the DSC 1601 (S1110 and S1208). The DSC 102 receives a radio wave from a GPS satellite 104, and compares the effective conditions with the present position (S915).

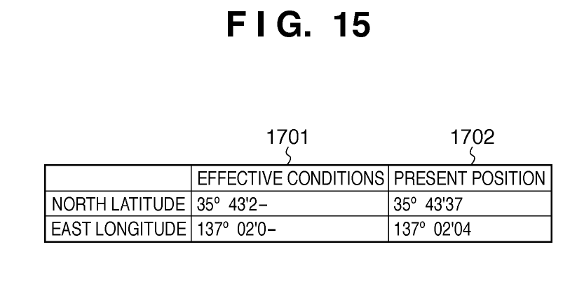

FIG. 15 is a view showing the state of a position information memory 306 of the DSC 102. The position information memory 306 of the DSC 102 is configured to store a present position 1702 and effective conditions 1701 of the DSC 102.

In the example shown in FIG. 15, the present position 1702 of the DSC 102 meets the effective condition on the longitude, but does not meet that on the latitude. In this case, a comparator 307 of the DSC 102 determines that the communication parameter currently being used is not valid and has been transmitted from an unintended apparatus (NO in S1901).

Accordingly, the DSC 102 erases the communication parameter received in S1110 from a communication parameter management unit 305 (S1801 and S1902), and restarts a communication parameter setting process (S1802 and S1903), thereby performing an operation of acquiring a new communication parameter.

In the third embodiment as has been explained above, when a communication parameter is received from an unintended wireless communication terminal, a wireless communication apparatus can determine, based on the position information of its own present position, whether the partner having transmitted the communication parameter currently being used is an intended partner.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-015589, filed Jan. 27, 2009, which is hereby incorporated by reference herein in its entirety.

What is claimed is:

1. A communication apparatus comprising:
an acquisition unit configured to acquire geographic position information indicating a position where the communication apparatus exists; and
a determination unit configured to determine availability of a communication parameter to be used when communicating with another apparatus, based on the position information acquired by said acquisition unit.

2. The apparatus according to claim 1, wherein said determination unit determines the availability of the communication parameter based on whether the position information acquired by said acquisition unit is included in a geographic range within which the communication parameter is usable.

3. The apparatus according to claim 1, further comprising a decision unit configured to decide a geographic range within which a communication parameter to be used when communicating with another apparatus is usable, based on the position information acquired by said acquisition unit.

4. The apparatus according to claim 3, further comprising a transmitting unit configured to transmit the communication parameter and information indicating the range decided by said decision unit to another communication terminal.

5. The apparatus according to claim 1, further comprising a control unit configured to control the communication apparatus to perform communication by using a new communication parameter, if said determination unit determines that a communication parameter currently being used is unavailable.

6. A communication apparatus comprising:
an acquisition unit configured to acquire geographic position information indicating a position where the communication apparatus exists; and
a decision unit configured to decide a geographic range within which a communication parameter to be used when communicating with another apparatus is usable, based on the position information acquired by said acquisition unit.

7. The apparatus according to claim 6, further comprising a generation unit configured to generate the communication parameter,
wherein said decision unit decides the range when said generation unit generates the communication parameter.

8. A communication apparatus comprising:
a receiving unit configured to receive a communication parameter to be used when communicating with another apparatus, and range information indicating a geographic range within which the communication parameter is usable;
an acquisition unit configured to acquire geographic position information indicating a position where the communication apparatus exists; and
a determination unit configured to determine availability of the communication parameter based on the position information acquired by said acquisition unit and the range information received by said receiving unit.

9. A control method of a communication apparatus, comprising the steps of:
acquiring geographic position information indicating a position where the communication apparatus exists; and
restricting use of a communication parameter to be used when communicating with another apparatus, based on the position information acquired in the acquiring step.

10. A control method of a communication apparatus, comprising the steps of:
acquiring geographic position information indicating a position where the communication apparatus exists; and
deciding a range which restricts use of a communication parameter to be used when communicating with another apparatus, based on the position information acquired in the acquiring step.

11. A control method of a communication apparatus, comprising the steps of:
receiving a communication parameter to be used when communicating with another apparatus, and range information indicating a geographic range within which the communication parameter is usable;
acquiring geographic position information indicating a position where the communication apparatus exists; and
restricting use of the communication parameter based on the position information acquired in the acquiring step and the range information received in the receiving step.
